(19) United States
(12) Patent Application Publication
(10) Pub. No.: US 2015/0002334 A1
(43) Pub. Date: Jan. 1, 2015

(54) POSITIONING SYSTEM AND METHOD BASED ON CHANNEL FROM GROUND CONTROL CENTER TO AEROSPACE RELAY NODE

(71) Applicant: Ajou University Industry-Academic Cooperation Foundation, Suwon (KR)

(72) Inventors: Jae Sung Lim, Suwon (KR); Ji Nyoung Jang, Suwon (KR); Kyu Man Lee, Suwon (KR)

(73) Assignee: Ajou University Industry-Academic Cooperation Foundation

(21) Appl. No.: 14/318,034

(22) Filed: Jun. 27, 2014

Related U.S. Application Data
(63) Continuation of application No. PCT/KR2012/011480, filed on Dec. 26, 2012.

(30) Foreign Application Priority Data
Dec. 28, 2011 (KR) 10-2011-0144427
Aug. 1, 2012 (KR) 10-2012-0084477

(51) Int. Cl. G01S 19/10

(52) U.S. Cl. CPC G01S 19/10
USPC 342/357.47

(57) ABSTRACT

The present invention relates to a positioning system, and more particularly, to a positioning system, a positioning method and an apparatus for same, in which a ground reference node transmits information on the location of an aerospace/satellite relay node and the location of the ground reference node to a receiving node, and the location of the receiving node is calculated using the information on the location of the aerospace/satellite relay node and the location of the ground reference node received at the receiving node.

### CROSS-REFERENCE TO RELATED APPLICATION

This application is a continuation of PCT/KR2012/011480 filed on Dec. 26, 2012, which claims priority to Korean Application No. 10-2011-0144427 filed on Dec. 28, 2011, and Korean Application No. 10-2012-0084477 filed on Aug. 1, 2012, which applications are incorporated herein by reference.

### TECHNICAL FIELD

The present invention relates to a positioning system and, more particularly, to a positioning system, method and apparatus, in which a ground reference node sends information about the locations of aerospace/satellite relay nodes and the location of a ground reference node to a reception node and the location of the reception node is calculated using information about the locations of the aerospace/satellite relay nodes and the location of the ground reference node received from the reception node.

### BACKGROUND ART

A method of obtaining information about the location, altitude, and speed of an object on the ground by using artificial satellites that revolve along a space orbit is commonly called a Global Navigation Satellite System (GNSS).

A GNSS can determine even accurate location information having a resolution equal to or lower than 10 m, and is widely applied to the guidance of the location of means of transportation, such as an airplane, a vessel and a vehicle, and civilian fields, such as land surveying, emergency relief and communication, as well as military uses.

A GNSS includes a receiver capable of receiving signals from one or more artificial satellites, a ground monitoring node, and a system preservation monitoring system. A GNSS uses a method in which a receiver receives electric waves transmitted by the artificial satellites, calculates the distances from the satellites, and determines the location of the receiver. A GNSS is considered to be advantageous in that signals may be used when a receiver is provided regardless of the geographical location of a user, the size of the receiver is small, and a task can be performed while in motion because output can be obtained in real time.

Of existing GNSSs, a Global Positioning System (GPS) developed and managed by U.S. Department of Defense is exclusively used. In response to this, Russia is constructing a GLObal NAvigation Satellite System (GLONASS), Europe is constructing Galileo, and China is constructing Beidou ( [symbol] ).

The GPS exclusively possessed by U.S. Department of Defense includes three parts: a space segment, a user segment, and a control segment.

The operating principle of the GPS is as follows. A receiver receives navigation messages from the satellites, and determines a location by calculating the location. The receiver should be aware of the ones of 24 satellites from which signals been received. It is impossible to determine which satellites have sent the signals based on the frequency because all the satellites send their data over the same frequency.

Accordingly, independent ID codes are assigned to respective satellites, and sending satellites are determined. When signals are received from the satellites, the receiver determines satellites from which the signals have been received by searching for IDs matching the IDs of all the satellites, obtains navigation data, and then calculates the location.

However, an error occurs due to bad weather because the speeds of signals transmitted by the GPSs are affected by the ionosphere and the troposphere. A middle earth orbit satellite navigation system having weak received signal strength may generate a great obstacle in military use or in a disaster situation because GPS signals in the range of 50 to 100 km can be jammed by jamming equipment mounted on a ground vehicle.

For these reasons, efforts have been made to supplement the weak signals of the GPS and compensate for the error of the GPS by using a ground communication network. One of these efforts is a hybrid satellite navigation system, such as that set forth in Korean Patent Application Registration No. 10-0411758. However, if the location information of the GPS is supplemented using a ground communication network, a disadvantage arises in that accurate location information may be limited in a downtown area.

Accordingly, there is a need for the development of a positioning system that does not belong to existing technologies exclusively depending on the GPS when national security is taken into account, that is less sensitive to jamming and error, and that can provide more accurate location information.

### SUMMARY OF THE DISCLOSURE

Recently, the military pushes forward with the advancement of weapon systems. The positioning systems of such precision weapon systems are basically based on the GPS. However, it has been known that in a middle earth orbit satellite navigation system having weak received signal strength, GPS signals in the range of 50 to 100 km can be jammed by jamming equipment mounted on a ground vehicle. A GPS jamming situation that also occurred in the northwest part of the Metropolitan area in Korea reveals vulnerability to the jamming of GPS signals. That is, the development of a system that depends exclusively on the GPS should be rejected, but it is difficult to fundamentally overcome the jamming of low-power positioning signals because of the characteristics of GPS signals generated by a middle earth orbit satellite.

In particular, with the recent development of IT technology, technologies for RF sources and an antenna having a small size and high output have been developed, and electromagnetic jamming equipment can be developed and managed at a low cost. The jamming of GPS signals performed by major threatening parties and antisocial terror groups may become a great calamity to the human race.

That is, it is necessary to develop a system that is capable of supporting the defense/security/disaster complex capability to perform the collection and control of position/situation information, which supports the capability to manage a national security system, a disaster warning system, and industry infrastructure networking. There is a need for the development of a positioning system having the proposed capability from the viewpoint of such national security.

Accordingly, an object of the present invention is to develop an independent positioning system structure and a technology for implementing the structure, which are capable of supporting the defense/security/disaster complex capability to perform the collection and control of position/situation information, which supports the capability to manage a national security system, a disaster warning system and industry infrastructure networking using a ground reference node and aerospace/satellite relay nodes without depending on a positioning system based on a conventional middle earth orbit satellite having a global service capability.

To achieve the above object, a positioning system according to an embodiment of the present invention includes a ground reference node, aerospace/satellite relay nodes, and a reception node.

The ground reference node shares information about the locations of three or more aerospace/satellite relay nodes and information about the location of the ground reference node with the reception node. In this case, a network used may be an aerospace/satellite network, but a heterogeneous communication network may be used.

Furthermore, the ground reference node sends reference signals to the reception node by using an aerospace/satellite network extending via the three or more aerospace/satellite relay nodes.

Furthermore, the aerospace/satellite relay nodes amplify signals, and transfer reception signals, received by the ground reference node, to the ground.

The reception node uses Times Of Arrival (TOAs) or Time Differences Of Arrival (TDOAs) related to the transfer paths of the reference signals, and calculates the location of the reception node by using the location of the ground reference node and the locations of the respective aerospace/satellite relay nodes.

In a positioning system according to a first embodiment of the present invention, a ground reference node may send positioning-related information to a reception node in an asynchronous way. In this case, the reception node may calculate the differences between the distances from three or more aerospace/satellite relay nodes to the reception node based on TDOAs related to the transfer paths of reference signals that are transferred from the ground reference node to the reception node via the respective aerospace/satellite relay nodes.

The reception node may calculate the location of the reception node using the differences between the distances from the aerospace/satellite relay nodes to the reception node. In this case, hyperbolic navigation may be used as an example of a method of calculating the location of the reception node by using the TDOAs of the reference signals.

In a positioning system according to a second embodiment of the present invention, synchronized time information may be used between a ground reference node and a reception node. The ground reference node may generate the code signals of aerospace/satellite relay nodes by using the synchronized time information. The reception node may generate the code signals of the respective aerospace/satellite relay nodes at the same time as the ground reference node by using the time information synchronized with the ground reference node.

The code signals generated by the ground reference node may be transferred to the reception node via the respective aerospace/satellite relay nodes that correspond to the respective code signals. The reception node may calculate Round Trip Times (RTTs) related to transfer paths extending via the aerospace/satellite relay nodes based on the times at which the code signals was generated, and TODAs. The reception node may calculate the distances from the aerospace/satellite relay nodes to the reception node by using transfer delay times related to the distances from the ground reference node to the aerospace/satellite relay nodes and the RTTs related to the transfer paths corresponding to the aerospace/satellite relay nodes.

The reception node may calculate the location of the reception node by using the distances from the aerospace/satellite relay nodes to the reception node. In this case, a triangulation method may be used as an example of a method of determining the location of the reception node.

In a positioning system according to a third embodiment of the present invention, a ground reference node may broadcast information about the location of the ground reference node and the locations of respective aerospace/satellite relay nodes by using an aerospace/satellite network extending via one or more of the aerospace/satellite relay nodes or a separate wired or wireless communication network.

In a positioning system according to a fourth embodiment of the present invention, information about aerospace/satellite relay nodes may be included in reference signals transferred via aerospace/satellite relay nodes, and may be transmitted by a ground reference node.

Furthermore, in accordance with yet another embodiment of the present invention, the reception node may feed back information so that the ground reference node may control the power level of each reference signal when sending the reference signals by sending the measured value of a downlink channel over which information about a surrounding environment or the reference signals is received via an uplink. The ground reference node may obtain information about an unexpected situation, such as a natural disaster and an artificial accident, based on transmission information from the reception node. As described above, in the positioning system of the present invention, an aerospace/satellite communication network is used for positioning and also hybrid data communication through which positioning-related information and other types of information are transmitted and received in parallel may be used.

In accordance with yet another embodiment of the present invention, the ground reference node may be a central node that directly controls the aerospace/satellite relay nodes, and may operate in such a manner that it receives information about each of the aerospace/satellite relay nodes from the central node in real time or at specific intervals.

In accordance with yet another embodiment of the present invention, if a plurality of the ground reference nodes is present and positioning-related information is provided by the ground reference nodes to the reception node via the aerospace/satellite relay nodes, the reception node may combine differences in time between reception signals, may calculate the locations of the aerospace/satellite relay nodes by combining the differences in time, and may calculate the location of the reception node by using the calculated locations. In this case, the reception node may periodically receive the locations of the respective aerospace/satellite relay nodes from one of the plurality of ground reference nodes, may determine the accuracy of the locations of the respective aerospace/satellite relay nodes, and may compensate for the inaccuracy of the locations of the aerospace/satellite relay nodes calculated by the reception node for itself.

A positioning system according to yet another embodiment of the present invention includes a central node, three or more ground reference nodes, three or more aerospace/satellite relay nodes, and a reception node.

In this case, the central node synchronizes the ground reference nodes, monitors satellite relay signals, and assigns ground reference node codes and transmission frequencies.

Furthermore, the three or more ground reference nodes may send unique signals to the three or more aerospace/satellite relay nodes via the assigned codes and frequencies. The aerospace/satellite relay nodes may superpose and send the received unique signals to the reception node. In this case, the aerospace/satellite relay nodes may amplify the received unique signals and send back the amplified signals to the reception node.

The reception node calculates the locations of the aerospace/satellite relay node based on TDOAs between the superposed unique signals received from the three or more aerospace/satellite relay nodes, and calculates its own location based on the calculated locations of the three or more aerospace/satellite relay nodes and TOAs between the reception nodes. A process in which the reception node calculates its own location and the locations of the aerospace/satellite relay nodes is possible in accordance with a triangulation method using the obtained distances.

Furthermore, the reception node may send the received measured value of the downlink channel or the received information about a surrounding environment to the ground reference node via an uplink. The ground reference node may control the power level of a transmission signal by using the feedback channel measured value or information about a surrounding environment.

In this case, the reception node may generate additional information via an uplink based on a secured transmission capability. The additional information may be transmitted by using low-speed message communication, etc. Bidirectional communication is also possible between the ground reference node or the central node and the reception node. Transmitted information may be various types of information, such as weather information, unexpected situation information, and disaster information around the reception node.

The present invention can improve the malicious signal jamming handling capability compared to a conventional GNSS system that is vulnerable to malicious signal jamming, can lower dependence on the GNSS by applying the present invention to a national defense field weapon system, and can provide the positioning capability for a weapon system even in a GNSS signal jamming situation.

The present invention can be used in the positioning systems of various types of fields, such as civilian fields, the identification of the locations of merchant ships/fishing boats on the sea, harbor/aviation/traffic control, and the management of facilities. Furthermore, the present invention can be managed along with a disaster broadcasting system because a low-speed message related to aerospace/satellite communication relay can be broadcast to the reception node. If the reception node has the transmission capability, the reception node may also function as a sensor node through low-speed message communication. This enables bidirectional communication between the reception node and the ground reference node. In this case, the present invention may be managed along with a disaster broadcasting system or an emergency broadcasting system. Furthermore, since the transmission power level of the ground reference node can be controlled by using information fed back by the reception node, the present invention may also be applied to a hybrid data communication scheme in which various types of information are transmitted and received along with positioning-related information.

The positioning system of the present invention may be implemented by using a single ground reference node and three or more aerospace/satellite relay nodes. In this case, the reception node can relatively simply implement a process of calculating its location because information about the locations of the ground reference nodes and the aerospace/satellite relay nodes is provided by the ground reference node to the reception node.

Furthermore, the positioning system according to another embodiment of the present invention may be implemented by using three or more ground reference nodes (ground reference nodes) and three or more aerospace/satellite relay nodes. In this case, the reception node can calculate its location for itself even when information about the locations of the ground reference nodes and the aerospace/satellite relay nodes is not provided to the reception node.

Furthermore, the positioning system of the present invention can compare information about the locations of the aerospace/satellite relay nodes, calculated by the reception node, with location information transmitted by the ground reference node, and can supplement or compensate for the inaccuracy of the location information by using the case where a single ground reference node and three or more aerospace/satellite relay nodes are used and the case where three or more ground reference nodes and three or more aerospace/satellite relay nodes are used in parallel.

### BRIEF DESCRIPTION OF THE DRAWINGS

FIG. 1 illustrates the configuration of a ground reference node-based asynchronous communication relay positioning system including a ground reference node and a reception node according to an embodiment of the present invention;

FIG. 2 illustrates the configuration of a ground reference node-based synchronous communication relay positioning system including a ground reference node and a reception node according to an embodiment of the present invention;

FIG. 3 illustrates the conceptual configuration of the reception node according to an embodiment of the present invention;

FIG. 4 illustrates a conceptual configuration of the reception node capable of feedback according to an embodiment of the present invention;

FIG. 5 illustrates an operational flowchart of a positioning method that is performed in the ground reference node-based communication relay positioning system according to an embodiment of the present invention;

FIG. 6 illustrates an operational flowchart of a method of monitoring the locations of the aerospace/satellite relay nodes based on the ground reference node and sending positioning information according to an embodiment of the present invention;

FIG. 7 illustrates an operational flowchart of a method in which the asynchronous positioning system calculates the location of a reception node according to an embodiment of the present invention;

FIG. 8 illustrates an operational flowchart of a method in which the synchronous positioning system calculates the location of the reception node according to an embodiment of the present invention;

FIG. 9 illustrates an operational flowchart of a process in which the synchronous positioning system determines the location of the reception node using a triangulation method according to an embodiment of the present invention;

FIG. 10 illustrates an operational flowchart of a method in which the ground reference node broadcasts location information according to an embodiment of the present invention;

FIG. 11 illustrates an operational flowchart of a method in which the ground reference node imposes location information onto reference signals and code signals and then send the location information to the reception node according to an embodiment of the present invention;

FIG. 12 illustrates an operational flowchart of a method in which the reception node extracts information about the locations of aerospace/satellite relay nodes from reference signals according to an embodiment of the present invention, which corresponds to FIG. 11;

FIG. 13 illustrates the conceptual configuration of the reception node in the synchronous positioning system according to an embodiment of the present invention;

FIG. 14 illustrates the configuration of a three or more ground reference nodes-based aerospace/satellite communication relay positioning system according to an embodiment of the present invention;

FIG. 15 illustrates a conceptual configuration of the reception node illustrated in FIG. 14;

FIG. 16 illustrates a conceptual configuration of the reception node capable of feedback, illustrated in FIG. 14;

FIG. 17 illustrates an operational flowchart of a positioning method that is performed in the three or more ground reference nodes-based aerospace/satellite communication relay positioning system according to an embodiment of the present invention;

FIG. 18 is an operational flowchart illustrating step S1730 of FIG. 17 in more detail; and

FIG. 19 is an operational flowchart illustrating a feedback process in the reception node according to an embodiment of the present invention, which corresponds to FIG. 17.

### DETAILED DESCRIPTION OF THE DISCLOSURE

In addition to the above object, other objects and characteristics of the present invention will become apparent from a detailed description of embodiments given with reference to the accompanying drawings.

Preferred embodiments of the present invention are described in detail with reference to the accompanying drawings. In the description of the embodiments of the present invention, detailed descriptions of the known functions and configurations will be omitted if they are deemed to make the gist of the present invention unnecessarily ambiguous.

However, the present invention is not limited or restricted to the embodiments. The same reference numerals presented in the drawings designate the same components.

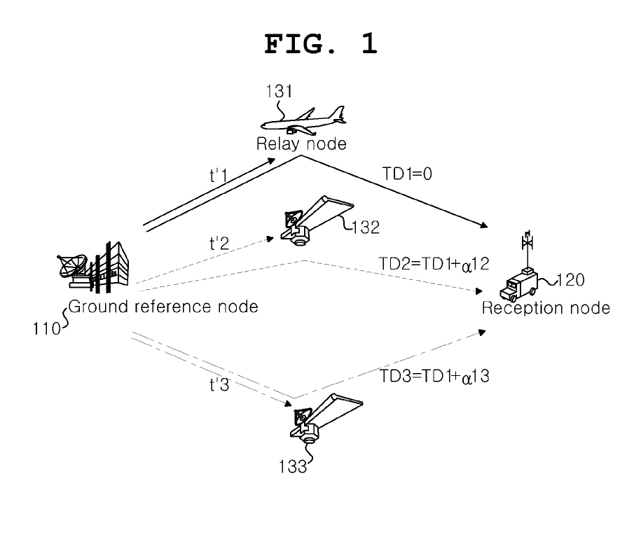

FIG. 1 illustrates the configuration of a ground reference node-based asynchronous communication relay positioning system including a ground reference node and a reception node according to an embodiment of the present invention.

As illustrated in FIG. 1, the positioning system according to the present invention includes a ground reference node 110, three or more aerospace/satellite relay nodes 131, 132 and 133, and a reception node 120.

In this case, the reception node 120 refers to a concept including one or more of a communication terminal/device, such as a mobile phone, a positioning apparatus installed on a vessel or a vehicle, and a satellite signal reception device.

The aerospace/satellite relay node 131 refers to a concept including one or more of a nodeary orbit communication satellite, an artificial satellite having a forwarding/communication function, and a flying body having a forwarding/communication function. In the positioning system of the present invention, the locations of the aerospace/satellite relay nodes 131, 132 and 133 may be fixed, but does not need to be necessarily fixed.

The ground reference node 110 determines the locations of the three or more aerospace/satellite relay nodes 131, 132 and 133 by continuously monitoring the locations of the aerospace/satellite relay nodes 131, 132 and 133 in order to perform the posture control and other types of control of the aerospace/satellite relay nodes 131, 132 and 133. Thereafter, the ground reference node 110 sends information about the locations of the three or more aerospace/satellite relay nodes 131, 132 and 133 and information about the location of the ground reference node 110 to the reception node 120 via the aerospace/satellite relay nodes 131, 132 and 133.

In this case, in accordance with an embodiment of the present invention, the location of the ground reference node 110 may be previously known to the reception node 120. In accordance with another embodiment of the present invention, information about the location of the ground reference node 110 may be transferred to the reception node 120 along with information about the locations of the aerospace/satellite relay nodes 131, 132 and 133.

The aerospace/satellite relay nodes 131, 132 and 133 receive code signals from the ground reference node 110, amplify the code signals, and superpose and send the amplified signals to the reception node 120.

The reception node 120 calculates the distances between the reception node 120 and the three or more aerospace/satellite relay nodes 131, 132 and 133 by using received information about the locations of the aerospace/satellite relay nodes 131, 132 and 133 and the Time Differences Of Arrival (TDOAs) of the reference signals of the ground reference node 110 that arrive at the reception node 120 via the aerospace/satellite relay nodes 131, 132 and 133, thereby calculating the location of the reception node 120. An example of a technique that may be used in this case includes hyperbolic navigation.

In this case, the reception node 120 may calculate transfer delay times t′1, t′2 and t′3 based on the distances from the ground reference node 110 to the respective aerospace/satellite relay nodes 131, 132 and 133 because the reception node 120 is provided with the location of the ground reference node 110 and the locations of the aerospace/satellite relay nodes 131, 132 and 133 by the ground reference node 110.

The reception node 120 may calculate a12, that is, the difference between a transfer delay time TD1 from the relay node 131 to the reception node 120 and a transfer delay time TD2 from the relay node 132 to the reception node 120. Likewise, the reception node 120 may calculate a13, that is, the difference between a transfer delay time TD1 from the relay node 131 to the reception node 120 and the transfer delay time TD3 from the relay node 133 to the reception node 120.

The reception node 120 may calculate the location of the reception node 120 by using a12 and a13 and the locations of the relay nodes 131, 132 and 133.

In accordance with an embodiment of the present invention, when the ground reference node 110 sends reference signals, it may send the reference signals to the different aerospace/satellite relay nodes 131, 132 and 133 at the same time. In this case, the reception node 120 needs to calculate the transfer delay times it takes for the reference signals to be transferred by the ground reference node 110 via uplinks by taking into account the distances between the location of the ground reference node 110 and the locations of the aerospace/satellite relay nodes 131, 132 and 133, and needs to compensate for the value of the TDOA by taking into account the uplink transfer delay times.

In accordance with another embodiment of the present invention, when the ground reference node 110 sends the reference signals, the times at which reference signals are transmitted may vary depending on transfer paths so that the reference signals from the different aerospace/satellite relay nodes 131, 132 and 133 are returned to the ground at the same time (i.e., so that the reference signals are transmitted to the reception node 120 at the same time). In this case, since the differences between the uplink transfer delay times are naturally eliminated, the computational load of the reception node 120 can be reduced. The reference node 110 may control the transmission times at which the reference signals are transmitted via the respective transfer paths because it continuously monitors the locations of the aerospace/satellite relay nodes 131, 132 and 133.

Furthermore, in accordance with yet another embodiment of the present invention, the reception node 120 may send information about a surrounding environment or the measured values of downlink channels, through which the reference signals are received, via an uplink, and may feed back information so that the ground reference node 110 may control its power level when sending the reference signal. Furthermore, the ground reference node 110 may obtain information about an unexpected situation, such as a natural disaster or an artificial accident, based on transmission information from the reception node 120. As described above, in the positioning system of the present invention, an aerospace/satellite communication network is used for positioning, and also hybrid data communication in which positioning-related information and another type of information are transmitted in parallel may be used.

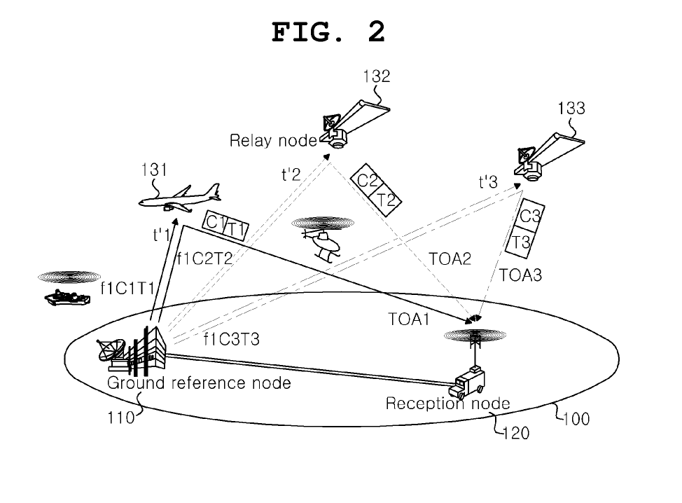

FIG. 2 illustrates the configuration of a ground reference node-based synchronous communication relay positioning system including a ground reference node and a reception node according to an embodiment of the present invention.

In this case, all code signals that are transmitted by the ground reference node 110 are synchronized, and are transmitted to the aerospace/satellite relay nodes 131, 132 and 133 at the same time.

The ground reference node 110 may send code information C1 in a time slot T1 via the same frequency band f1, and may send the code information C1 to the aerospace/satellite relay node 131 via broadcasting. The ground reference node 110 may send code information C2 in a time slot T2 via the same frequency band f1, and may send the code information C2 to the aerospace/satellite relay node 132 through broadcasting. The ground reference node 110 may send code information C3 in a time slot T3 via the same frequency band f1 to the aerospace/satellite relay node 133 through broadcasting. In this case, the code information C1, C2 and C3 are codes including information about the unique IDs of the respective aerospace/satellite relay nodes 131, 132 and 133. The time slots T1, T2 and T3 are time slots that are assigned to the aerospace/satellite relay nodes 131, 132 and 133.

Although in the embodiment of FIG. 2, the case where the frequency band is constant, that is, f1, and the different time slots T1, T2 and T3 are assigned to the respective relay nodes has been illustrated, a case where the same time slot is provided and different frequency bands are assigned to the respective relay nodes is possible. As described above, it may be apparent to those skilled in the art that a change is made by referring to the embodiment of FIG. 2 such that different resources are assigned to the respective aerospace/satellite relay nodes.

The aerospace/satellite relay nodes 131, 132 and 133 receive code signals from the ground reference node 110, amplify the code signals, and superpose and send the amplified signals to the reception node 120.

The reception node 120 may generate the code signals of the respective aerospace/satellite relay nodes 131, 132 and 133 at the same time as the ground reference node 110 by using time information synchronized with that of the ground reference node 110. The code signals generated by the ground reference node 110 are transmitted to the reception node 120 over an aerospace/satellite network.

The reception node 120 may calculate a total Round Trip Time (RTT) related to transfer paths via the respective aerospace/satellite relay nodes 131, 132 and 133 by using the difference between information about the times at which the code signals were generated (the time information synchronized with the ground reference node 110) and the Times Of Arrival (TOAs) of the code signals received via the respective aerospace/satellite relay nodes 131, 132 and 133, and may calculate the transfer delay time and distance between each of the aerospace/satellite relay nodes 131, 132 and 133 and the reception node 120 by subtracting each of uplink transmission times t′1, t′2 and t′3, calculated by using information about the determined locations of the three or more aerospace/satellite relay nodes 131, 132 and 133 and the location of the ground reference node 110, from the RTT. The travel distances between the aerospace/satellite relay nodes 131, 132 and 133 and the reception node 120 may be obtained by multiplying the transfer delay times between the aerospace/satellite relay nodes 131, 132 and 133 and the reception node 120 by the propagation speed of electromagnetic waves. The horizontal distances between the aerospace/satellite relay nodes 131, 132 and 133 and the reception node 120 may be calculated by using the altitudes of the aerospace/satellite relay nodes 131, 132 and 133. The reception node 120 calculates the location of the reception node 120 by using triangulation based on the horizontal distances between the aerospace/satellite relay nodes 131, 132 and 133 and the reception node 120.

Although in FIG. 2, the embodiment in which the same frequency f1 is assigned to the aerospace/satellite relay nodes 131, 132 and 133 has been illustrated, the present invention is not limited only to the embodiment of FIG. 2. As described above, an embodiment in which different frequency bands are assigned to the aerospace/satellite relay nodes 131, 132 and 133 is possible. If different frequency bands are assigned to the aerospace/satellite relay nodes 131, 132 and 133, the aerospace/satellite relay nodes 131, 132 and 133 may be identified by using a frequency division method, such as time division or code division. There is no limitation to a method of identifying the aerospace/satellite relay nodes 131, 132 and 133 because it is sufficient if the reception node 120 can identify relay nodes via which superposed and received unique codes have been received.

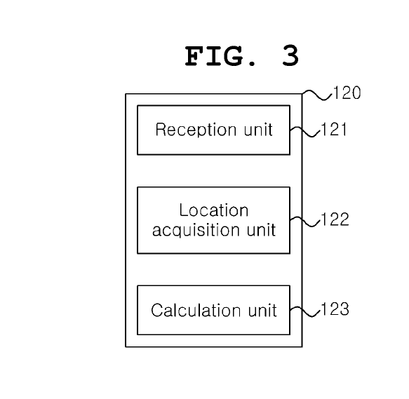

FIG. 3 illustrates the conceptual configuration of the reception node according to an embodiment of the present invention.

The reception node 120 includes a reception unit 121, a location acquisition unit 122, and a calculation unit 123. The reception unit 121 receives reference signals that are transmitted by the ground reference node 110 and that are received by the three or more aerospace/satellite relay nodes 131, 132 and 133, respectively.

In this case, in accordance with an embodiment of the present invention, the reception unit 121 may receive location information that is broadcast by the ground reference node 110.

In accordance with another embodiment of the present invention, the reception unit 121 may receive code signals in which the locations of the three or more aerospace/satellite relay nodes 131, 132 and 133 have been superposed on one another.

The location acquisition unit 122 shares location information with the ground reference node 110 in accordance with a predetermined method. In this case, location information to be shared includes the location of the ground reference node 110 and the locations of the three or more aerospace/satellite relay nodes 131, 132 and 133. In this case, the location acquisition unit 122 may share the location information with the ground reference node 110 over a predetermined network. In accordance with another embodiment of the present invention, the location acquisition unit 122 may use location information received by the reception unit 121, or may extract the locations of the three or more aerospace/satellite relay nodes 131, 132 and 133 from code signals in which the locations of the three or more aerospace/satellite relay nodes 131, 132 and 133 have been superposed on one another.

The calculation unit 123 calculates the distances from the respective aerospace/satellite relay nodes 131, 132 and 133 to the reception node 120 or the differences between the distances by using the locations of the ground reference node 110 and the three or more aerospace/satellite relay nodes 131, 132 and 133, which are obtained by the location acquisition unit 122, and also using TOAs or TDOAs based on the transfer paths of the reference signals received by the reception unit 121. Thereafter, the calculation unit 123 may calculate the location of the reception node 120 by using the calculated distances or the differences between the differences.

If the reception node 120 of FIG. 3 is applied to the asynchronous positioning system of FIG. 1, the calculation unit 123 may calculate TDOAs related to the transfer paths of the received reference signals, and may form a hyperbola, on which a constant difference in distance from the aerospace/satellite relay nodes 131, 132 and 133 is maintained, on geographical information by using the TDOAs and the locations of the aerospace/satellite relay nodes 131, 132 and 133. In this case, the calculation unit 123 may generate two or more hyperbolas, may search for an intersection point of the two or more hyperbolas, and may calculate the location of the reception node 120 on the geographical information. In this case, before the hyperbolas are generated from the TDOAs, the calculation unit 123 may subtract the transfer delay times t′1, t′2 and t′3, it takes for the reference signals to be transmitted by the ground reference node 110 via uplinks, from TOAs related to the respective transfer paths by using the locations of the ground reference node 110 and the aerospace/satellite relay nodes 131, 132 and 133.

If the reception node 120 of FIG. 3 is applied to the synchronous positioning system of FIG. 2, the calculation unit 123 calculates the location of the reception node 120 through triangulation by using the TOAs related to the transfer paths of the received reference signals and the locations of the three or more aerospace/satellite relay nodes 131, 132 and 133. The transmission times at the ground reference node 110 are the same because all the reference signals C1 to C3 received by the reception node 120 have been synchronized and then sent.

Accordingly, the calculation unit 123 may calculate the RTTs it takes for the respective reference signals of the ground reference node 110 to reach the reception node 130 via the respective aerospace/satellite relay nodes 131, 132 and 133 based on the times at which the reference signals reached the reception node 120 and the differences between the transmission times. Since the ground reference node 110 already knows the locations of the aerospace/satellite relay nodes 131, 132 and 133 through continuous monitoring, the calculation unit 123 may obtain the transfer delay times and distances between the aerospace/satellite relay nodes 131, 132 and 133 and the reception node 120 by excluding the uplink transfer delay times t′1, t′2 and t′3 between the ground reference node 110 and the aerospace/satellite relay nodes 131, 132 and 133 from the total RTTs of the reference signals.

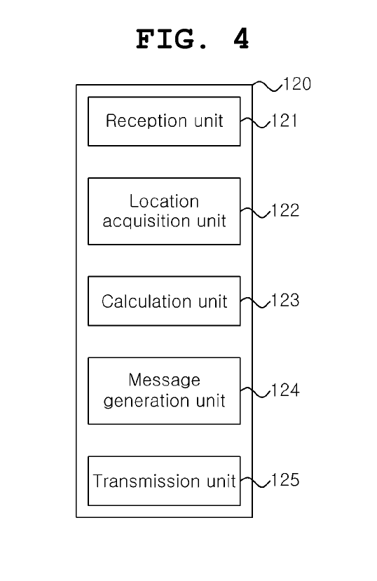

FIG. 4 illustrates the conceptual configuration of the reception node capable of feedback according to an embodiment of the present invention.

The operations of the reception unit 121, the location acquisition unit 122, and the calculation unit 123 of FIG. 4 are similar to those described with reference to FIG. 3, and thus descriptions thereof are omitted.

Referring to FIG. 4, the reception node 120 feeds back the measured value of a downlink channel over which a reference signal is received from the ground reference node 110 via the uplink of the transmission unit 125. Furthermore, the message generation unit 124 may generate a low-speed message depending on the surrounding environment of the reception node 120, and may send the low-speed message to the ground reference node 110 via an uplink. In this case, the message generated and transmitted by the reception node 120 may include the measured value of a downlink channel, or may include information about a weather environment, an unexpected situation, and a natural disaster around the reception node 120. The reception node 120 may feed back the channel measured value, and, if necessary, may generate a message indicative that a positioning process has failed due to poor channel characteristics and then feed back the generated message.

The reception node 120 may send information about a surrounding environment or channel characteristics to the ground reference node 110, and may also exchange information about a surrounding environment or channel characteristics with another reception node (not illustrated). In this case, the reception node 120 may communicate with surrounding reception nodes by using communication channels with the aerospace/satellite relay nodes 131, 132 and 133. The reception node 120 may communicate with another reception node under the control of the ground reference node 110, and may communicate with another reception node in an environment in which the reception node 120 is not controlled by the ground reference node 110. A mesh system may be formed in order for the reception node 120 to communicate with another reception node in the environment in which the reception node 120 is not controlled by the ground reference node 110.

In this case, the reception node 120 may send and receive information in the form of a short message in order to communicate with the ground reference node 110 or another reception node.

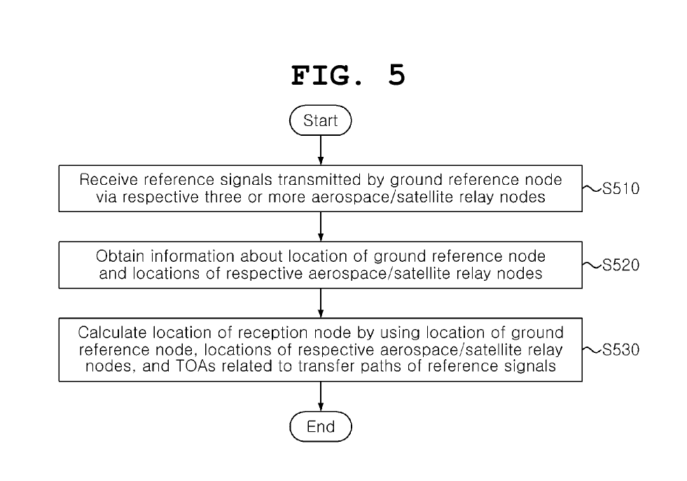

FIG. 5 illustrates an operational flowchart of a positioning method that is performed in the ground reference node-based communication relay positioning system according to an embodiment of the present invention. FIG. 5 is an illustration with a focus on an operation that is performed in the reception node 120.

The reception unit 121 of the reception node 120 receives reference signals that are transmitted by the ground reference node 110 and that are received via the three or more aerospace/satellite relay nodes 131, 132 and 133, respectively, at step S510.

The location acquisition unit 122 of the reception node 120 obtains information about the location of the ground reference node 110 and the locations of the respective aerospace/satellite relay nodes 131, 132 and 133 at step S520. In this case, step S520 performed by the location acquisition unit 122 of the reception node 120 may include receiving information about the location of the ground reference node 110, which is broadcast via at least one of the aerospace/satellite relay nodes 131, 132 and 133 or broadcast over a separate wired or wireless communication network, and also receiving information about the locations of the respective aerospace/satellite relay nodes 131, 132 and 133 from the ground reference node 110.

Furthermore, in accordance with another embodiment of the present invention, the location acquisition unit 122 of the reception node 120 may extract information about the locations of the aerospace/satellite relay nodes 131, 132 and 133 from the respective reference signals (when the location information is included in the reference signals and then transmitted) transferred via the respective aerospace/satellite relay nodes 131, 132 and 133.

Thereafter, the calculation unit 123 of the reception node 120 calculates the location of the reception node 120 by using the location of the ground reference node 110, the locations of the respective aerospace/satellite relay nodes 131, 132 and 133, and TOAs related to the transfer paths of the reference signals at step S530.

In this case, when the operational flowchart of FIG. 5 is applied to the asynchronous positioning system of FIG. 1, the calculation unit 123 calculates the differences between the distances from the aerospace/satellite relay nodes 131, 132 and 133 to the reception node 120 by using TDOAs related to the transfer paths of the reference signals and the locations of the respective aerospace/satellite relay nodes 131, 132 and 133. Thereafter, the calculation unit 123 determines the location of the reception node 120 by using the differences between the distances from the aerospace/satellite relay nodes 131, 132 and 133 to the reception node 120.

Furthermore, the calculation unit 123 may generate a hyperbola, that is, a set of specific points at which the difference between the distances from different aerospace/satellite relay nodes 131, 132 and 133 of the aerospace/satellite relay nodes 131, 132 and 133 is constant, on two or more geographical coordinates, and may determine the location of the reception node 120 by using the intersection point of the two or more hyperbolas.

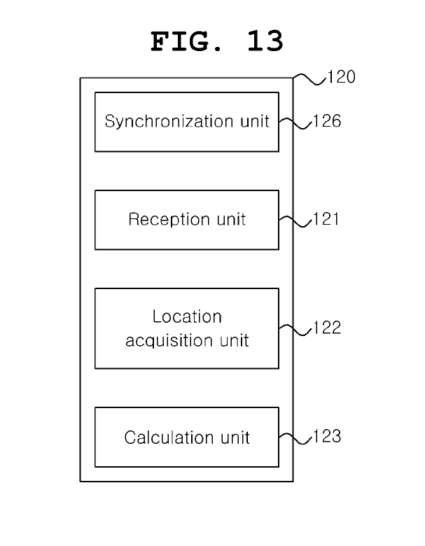

Alternatively, when the operational flowchart of FIG. 5 is applied to the synchronous positioning system of FIG. 2, the synchronization unit 126 of the reception node 120 generates the code signals of the respective aerospace/satellite relay nodes 131, 132 and 133 at the same time as that of the ground reference node 110 by using time information synchronized with the ground reference node 110. A conceptual diagram of the reception node 120 including the synchronization unit 126 is illustrated in FIG. 13.

The reception unit 121 of the reception node 120 receives the reference signals transferred via the respective aerospace/satellite relay nodes 131, 132 and 133 at step S510. The calculation unit 123 may calculate RTTs related to the transfer paths of the reference signals by comparing TOAs related to the transfer paths of the reference signals with the times at which code signals are generated.

The calculation unit 123 of the reception node 120 calculates the location of the reception node 120 by using the location of the ground reference node 110 and the information about the aerospace/satellite relay nodes 131, 132 and 133, obtained through step S520, and the RTTs related to the transfer paths at step S530.

In this case, the calculation unit 123 of the reception node 120 may calculate the uplink transfer delay times t′1, t′2 and t′3 of the respective transfer paths by using the location of the ground reference node 110 and the locations of the respective aerospace/satellite relay nodes 131, 132 and 133, and may calculate the transfer delay times and horizontal distances from the aerospace/satellite relay nodes 131, 132 and 133 to the reception node 120 by subtracting uplink transfer delay times t′1, t′2 and t′3 related to the respective transfer paths from RTTs related to the respective transfer paths.

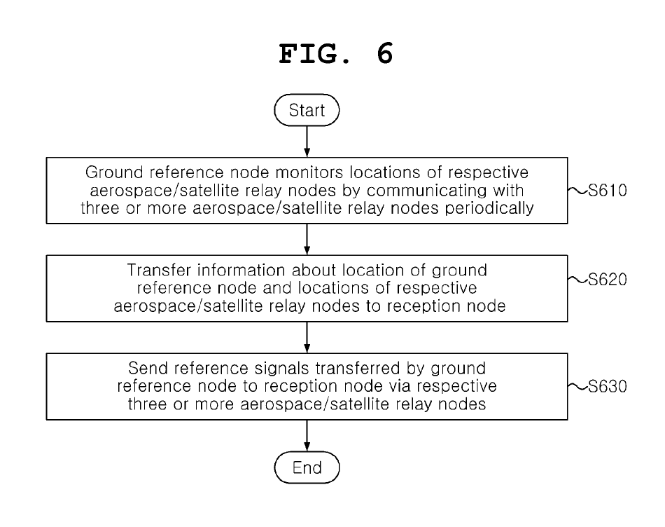

FIG. 6 illustrates an operational flowchart of a method of monitoring the locations of the aerospace/satellite relay nodes based on the ground reference node and sending positioning information according to an embodiment of the present invention. FIG. 6 is a diagram illustrating an operation that is performed by the ground reference node 110.

The ground reference node 110 communicates with the three or more aerospace/satellite relay nodes 131, 132 and 133 periodically in order to control the postures of the respective aerospace/satellite relay nodes 131, 132 and 133, and monitors the locations of the respective aerospace/satellite relay nodes 131, 132 and 133 at step S610. In this case, the ground reference node 110 may communicate with the three or more aerospace/satellite relay nodes 131, 132 and 133 at least periodically, and may monitor the locations of the respective aerospace/satellite relay nodes 131, 132 and 133 in real time. The ground reference node 110 may control the cycle (or period) in which the locations are monitored depending on whether each of the aerospace/satellite relay nodes 131, 132 and 133 is a nodeary orbit satellite, a middle earth orbit satellite, a low orbit satellite, or a flying body, and may control the cycle in which the locations are monitored depending on the degree that a communication environment or location is changed.

Thereafter, the ground reference node 110 transfers information about the location of the ground reference node 110 and the locations of the respective three or more aerospace/satellite relay nodes 131, 132 and 133 to the reception node 120 at step S620.

Thereafter, the ground reference node 110 sends the reference signals that are transferred from the ground reference node 110 to the reception node 120 via the respective three or more aerospace/satellite relay nodes 131, 132 and 133 at step S630.

In this case, the information about the locations may be broadcast via at least one of the aerospace/satellite relay nodes 131, 132 and 133 from the ground reference node 110 or via a communication channel different from that of the reference signal over a separate wired or wireless communication network. In this case, step S620 and step S630 may be performed as separate processes.

Furthermore, while the reference signals are transmitted, the information about the locations of the respective three or more aerospace/satellite relay nodes 131, 132 and 133 may be transferred to the reception node 120 via the aerospace/satellite relay node 131 that belongs to the three or more aerospace/satellite relay nodes 131, 132 and 133 and that corresponds to one of the pieces of information. In such a case, step S620 and step S630 may be merged, and may be performed through a single process.

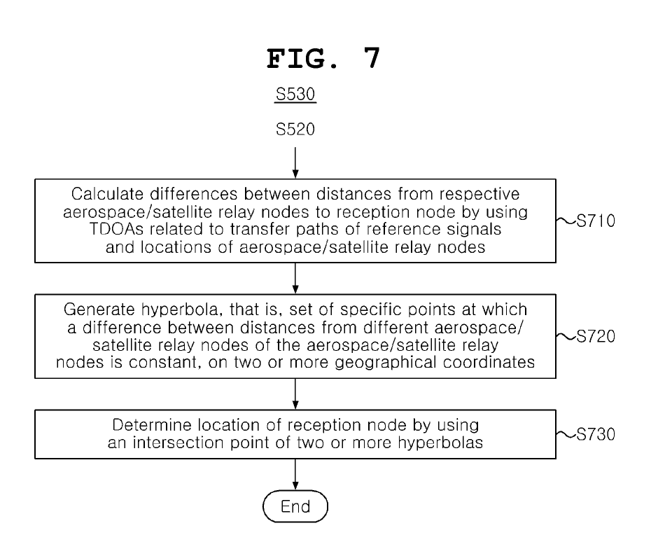

FIG. 7 illustrates an operational flowchart of a method in which the asynchronous positioning system calculates the location of a reception node according to an embodiment of the present invention.

The calculation unit 123 of the reception node 120 calculates the differences between the distances from the aerospace/satellite relay nodes 131, 132 and 133 to the reception node 120 by using TDOAs related to the transfer paths of the reference signals and the locations of the aerospace/satellite relay nodes 131, 132 and 133 at step S710.

Thereafter, the calculation unit 123 generates a hyperbola, that is, a set of specific points at which the difference between the distances from different aerospace/satellite relay nodes 131, 132 and 133 of the aerospace/satellite relay nodes 131, 132 and 133 is constant, on two or more geographical coordinates. In this case, a positioning method using two or more hyperbolas used is called hyperbolic navigation.

Thereafter, the calculation unit 123 determines the location of the reception node 120 by using the intersection point of the two or more hyperbolas at step S730.

Furthermore, if the ground reference node 110 sends the reference signals to the different aerospace/satellite relay nodes 131, 132 and 133 at the same time when sending the reference signals, the calculation unit 123 of the reception node 120 needs to calculate uplink transfer delay times by taking into account the distances between the location of the ground reference node 110 and the locations of the aerospace/satellite relay nodes 131, 132 and 133, and needs to compensate for the differences between the distances using the uplink transfer delay times at step S710.

Furthermore, if the time at which each reference signal is transmitted varies depending on each transfer path when the ground reference node 110 sends reference signals so that the reference signals from the different aerospace/satellite relay nodes 131, 132 and 133 are transmitted to the reception node 120 at the same time (i.e., so that the reference signals are returned at the same time), the computational load of the calculation unit 123 of the reception node 120 is reduced because the differences between the uplink transfer delay times are naturally eliminated. The ground reference node 110 can control the transmission times so that such results are obtained because it continuously monitors the locations of the aerospace/satellite relay nodes 131, 132 and 133.

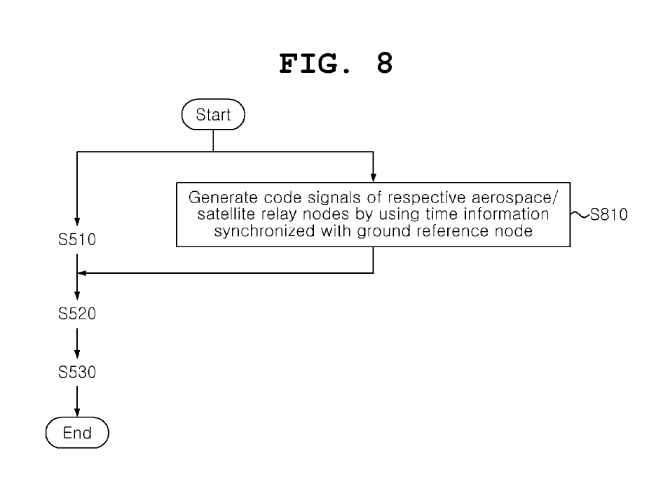

FIG. 8 illustrates an operational flowchart of a method in which the synchronous positioning system calculates the location of the reception node according to an embodiment of the present invention.

The synchronization unit 126 of the reception node 120 generates the code signals of the respective aerospace/satellite relay nodes 131, 132 and 133 by using time information synchronized with that of the ground reference node 110 at step S810.

The reception unit 121 of the reception node 120 receives the reference signals that are transmitted by the ground reference node 110 and that are transferred via the respective three or more aerospace/satellite relay nodes 131, 132 and 133 at step S510.

The calculation unit 123 may compare the TOAs of the transfer paths of the reference signals with the times at which code signals were generated, and may calculate the RTTs of the transfer paths of the reference signals.

The calculation unit 123 calculates the location of the reception node 120 by using information about the location of the ground reference node 110 and the locations of the aerospace/satellite relay nodes 131, 132 and 133 obtained at step S520 and the RTTs of the transfer paths at step S530.

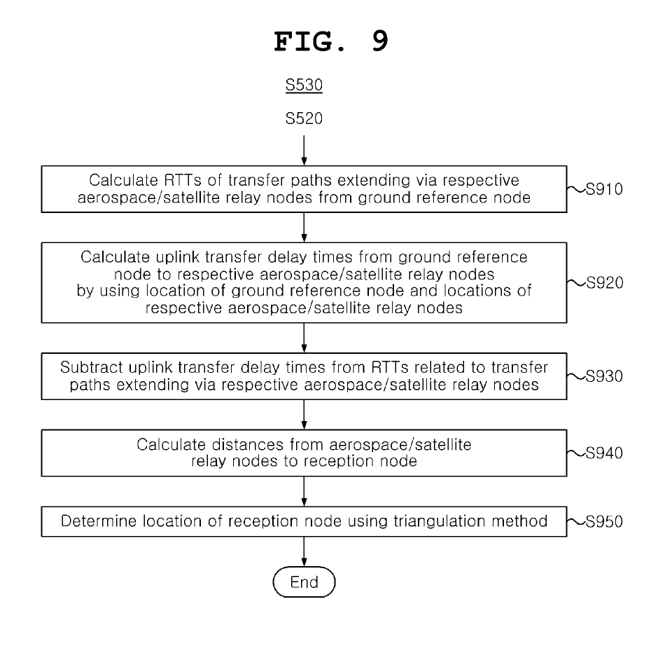

FIG. 9 illustrates an operational flowchart of a process in which the synchronous positioning system determines the location of the reception node using a triangulation method according to an embodiment of the present invention.

The calculation unit 123 of the reception node 120 calculates the RTTs of the transfer paths extending via the respective aerospace/satellite relay nodes 131, 132 and 133 from the ground reference node 110 at step S910.

Thereafter, the calculation unit 123 calculates uplink transfer delay times from the ground reference node 120 to the respective aerospace/satellite relay nodes 131, 132 and 133 by using the location of the ground reference node 120 and the locations of the respective aerospace/satellite relay nodes 131, 132 and 133 at step S920.

Thereafter, the calculation unit 123 subtracts the uplink transfer delay times from the RTTs of the transfer extending via the respective aerospace/satellite relay nodes 131, 132 and 133 at step S930, calculates the distances from the aerospace/satellite relay nodes 131, 132 and 133 to the reception node 120 at step S940, and determines the location of the reception node 120 using a triangulation method at step S950.

In this case, the triangulation method is a method of determining the coordinates and distance of any one point using the properties of a triangle. The triangulation method is a method of, if the one point and two reference points are given, measuring an angle formed by the base and each of the other two sides in a triangle formed by the one point and two reference points, measuring the length of each of the sides, and determining the coordinates and distance of the one point by performing a series of calculations using a sine law, etc.

The location of the reception node 120 may be determined by applying the triangulation method by using the locations of the respective three or more aerospace/satellite relay nodes 131, 132 and 133 and the distances from the aerospace/satellite relay nodes 131, 132 and 133 to the reception node 120.

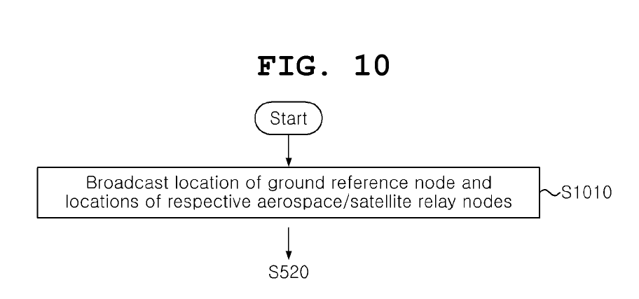

FIG. 10 illustrates an operational flowchart of a method in which the ground reference node broadcasts location information according to an embodiment of the present invention.

The ground reference node 110 broadcasts the location of the ground reference node 110 and the locations of the respective aerospace/satellite relay nodes 131, 132 and 133 at step S1010.

Thereafter, the location acquisition unit 122 of the reception node 120 obtains information about the location of the ground reference node 110 and the locations of the aerospace/satellite relay nodes 131, 132 and 133 at step S520. In this case, location information may be obtained by receiving the location information broadcast at S1010.

The broadcasting of step S1010 may be performed by using an aerospace/satellite network extending via any one of the aerospace/satellite relay nodes 131, 132 and 133, may be performed by using a channel different from channels over which the reference signals are transmitted, or may be performed over a heterogeneous wired or wireless communication network other than the aerospace/satellite network.

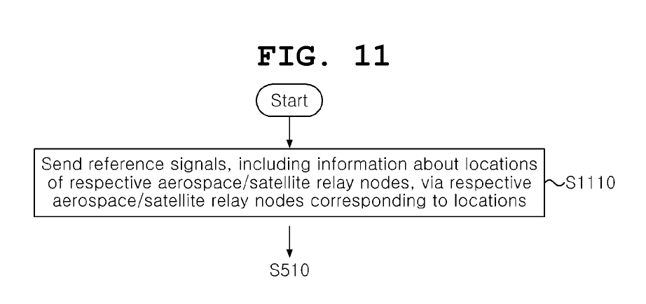

FIG. 11 illustrates an operational flowchart of a method in which the ground reference node imposes location information onto reference signals and code signals and then send the location information to the reception node according to an embodiment of the present invention.

The ground reference node 110 sends the reference signals, including information about the locations of the respective aerospace/satellite relay nodes 131, 132 and 133, via the respective aerospace/satellite relay nodes 131, 132 and 133 at step S1110.

Thereafter, the reception unit 121 of the reception node 120 receives the reference signals that are transmitted by the ground reference node 110 and that are transferred via the respective three or more aerospace/satellite relay nodes 131, 132 and 133 at step S510.

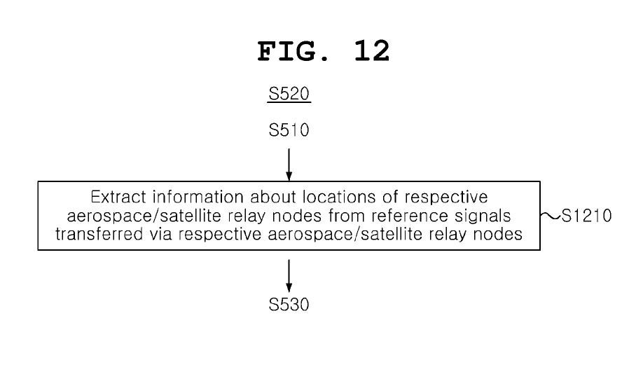

FIG. 12 illustrates an operational flowchart of a method in which the reception node extracts information about the locations of aerospace/satellite relay nodes from reference signals according to an embodiment of the present invention, which corresponds to FIG. 11.

After the reception unit 121 of the reception node 120 has received reference signals transmitted by the ground reference node 110 and transferred via the respective three or more aerospace/satellite relay nodes 131, 132 and 133 at step S510, the location acquisition unit 122 obtains information about the location of the ground reference node 110 and the locations of the aerospace/satellite relay nodes 131, 132 and 133 at step S520.

In this case, the location acquisition unit 122 may extract information about the locations of the respective aerospace/satellite relay nodes 131, 132 and 133 from the reference signals transferred via the respective aerospace/satellite relay nodes 131, 132 and 133 at step S1210.

Thereafter, the calculation unit 123 calculates the location of the reception node by using the location of the ground reference node 110, the locations of the respective aerospace/satellite relay nodes 131, 132 and 133 and TOAs or TDOAs related to the transfer paths of the reference signals at step S530.

As in the embodiments of FIGS. 11 and 12, if information about the locations of the respective aerospace/satellite relay nodes 131, 132 and 133 is included in the reference signals transferred over aerospace/satellite networks extending via the aerospace/satellite relay nodes 131, 132 and 133 and is transferred to the reception node 120, the security of the information about the locations of the respective aerospace/satellite relay nodes 131, 132 and 133 can be increased compared to the case where the information about the locations of the aerospace/satellite relay nodes 131, 132 and 133 is broadcast as in FIG. 10. In contrast, the computational load of the reception node 120 may be increased because the reception node 120 requires an additional process of extracting information about the locations of the aerospace/satellite relay nodes 131, 132 and 133 from the respective reference signals. In both cases where the location information is broadcast and the location information is imposed onto the reference signals and then transferred, the location information may be coded using a specific algorithm. In this case, the security performance of the location information can be further enhanced if only a specific reception node has an interpretation method or a password key for the corresponding algorithm and can access the location information.

FIG. 13 illustrates the conceptual configuration of the reception node in the synchronous positioning system according to an embodiment of the present invention.

The reception node 120 includes a reception unit 121, a location acquisition unit 122, and a calculation unit 123. The operations of the reception unit 121, the location acquisition unit 122, and the calculation unit 123 of FIG. 13 are similar to those described with reference to FIG. 3, and thus descriptions thereof are omitted.

Referring to FIG. 13, the synchronization unit 126 of the reception node 120 receives the reference signals from the ground reference node 110 and shares time information synchronized with the ground reference node 110.

In this case, RTTs related to the distances from the respective aerospace/satellite relay nodes 131, 132 and 133 to the reception node 120 are incorporated into the respective TOAs based on the transfer paths of the reference signals.

The ground reference node 110 described in various embodiments of the present invention is also called a ground control node (or a ground control center) as another name. It will be apparently understood by those skilled in the art that the ground reference node 110 does not mean only a central node that directly launches and manages the satellites 131 to 133 in a strict sense, but may include a civilian communication server which may receive information about the locations of the aerospace/satellite relay nodes 131 to 133 from a central node periodically or when necessary and then use the information.

In the aforementioned embodiments of the present invention, there have been proposed the positioning systems and methods in which the reception node 120 calculates its own location using the single ground reference node 110 and the three or more aerospace/satellite relay nodes 131, 132 and 133. In accordance with yet another embodiment of the present invention, a plurality of the ground reference nodes may be present. In particular, three or more ground reference nodes may be present. There may be a case where information related to positioning (e.g., reference signals) is transferred from three or more ground reference nodes to a reception node via three or more aerospace/satellite relay nodes. In this case, a case where reference signals are transferred by three ground reference nodes via three aerospace/satellite relay nodes is assumed, for convenience of description. The reception node may receive reference signals that have passed through nine different transfer paths.

Each of the ground reference nodes may appropriately distribute communication resources, such as transmission frequencies, transmission time slots, and code signals, and may send the reference signals so that how the reference signals have been transferred by which ground reference nodes via which aerospace/satellite relay nodes may be identified. It is assumed that the reception node already knows the locations of the respective three ground reference nodes. The reception node may calculate TOAs between the reference signals having passed through a single aerospace/satellite relay node from the three different ground reference nodes or TDOAs, and may calculate the location of the aerospace/satellite relay node using the TOAs or TDOAs. In this manner, the reception node may calculate the locations of the respective three aerospace/satellite relay nodes by using the TOAs of the respective reference signals that have passed through the three different aerospace/satellite relay nodes from the three different ground reference nodes and have eventually passed through different nine transfer paths, or the TDOAs.

The reception node may calculate the locations of the respective three aerospace/satellite relay nodes, and may calculate the distances from the three aerospace/satellite relay nodes to the reception node by using the transfer delay times of the reference signals from the three aerospace/satellite relay nodes to the reception node or the difference between the transfer delay times. The reception node may calculate the location of the reception node by using the locations of the respective three aerospace/satellite relay nodes and the distances from the respective three aerospace/satellite relay nodes to the reception node.

In an embodiment in which three ground reference nodes are used, the locations of the aerospace/satellite relay nodes does not need to be known to the reception node in advance, but the computation load of the reception node can be increased. In contrast, in an embodiment in which a single ground reference node is used, the locations of the aerospace/satellite relay nodes needs to be shared between the ground reference node and the reception node, but the computational load of the reception node can be reduced.

The embodiment in which the three ground reference nodes are used and the embodiment in which the single ground reference node is used may be implemented in parallel. That is, the reception node may basically calculate the locations of the respective aerospace/satellite relay nodes using the three ground reference nodes, and may calculate its own location. In this case, the ground reference node may provide the reception node with the locations of the aerospace/satellite relay nodes, determined by the ground reference node, periodically or in a special situation (if an error in the calculation of the location is increased, etc.) so that the reception node may determine the accuracy of the locations of the aerospace/satellite relay nodes, calculated by the reception node, and may compensate for the inaccuracy of the locations.

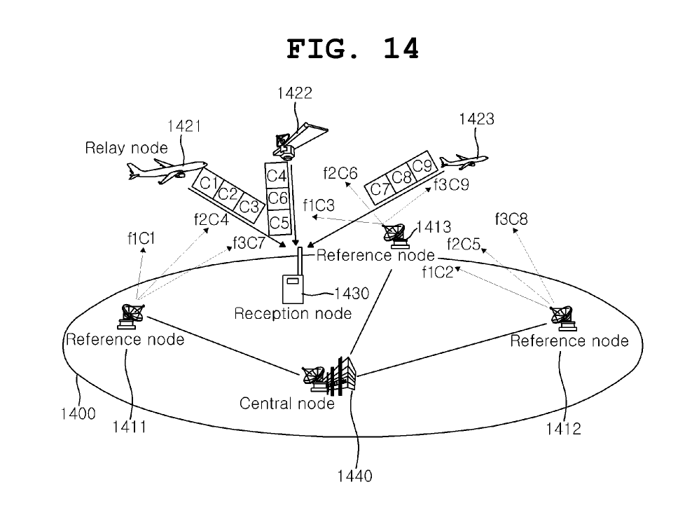

In accordance with an embodiment in which three ground reference nodes are used, FIG. 14 illustrates the configuration of a three or more ground reference nodes-based aerospace/satellite communication relay positioning system according to an embodiment of the present invention.

As illustrated in FIG. 14, the positioning system according to the present invention includes three or more ground reference nodes 1411, 1412 and 1413, three or more aerospace/satellite relay nodes 1421, 1422 and 1423, and a reception node 1430.

Furthermore, the ground reference nodes 1411, 1412 and 1413 are points, that is, references at which locations are measured. It is required that information about the precise locations of the ground reference nodes 1411, 1412 and 1413 may have been known to the reception node.

The ground reference node 1411 may assign different frequency bands f1, f2 and f3 to relay nodes 1421, 1422 and 1423. In this case, the assignment of the frequency bands to the respective relay nodes 1421, 1422 and 1423 may be performed by a central node 1440, and information about the assignment may be transferred to the ground reference nodes 1411, 1412 and 1423.

The ground reference node 1411 may impose the frequency band f1 onto code information C1 and then send the code information C1 with respect to the relay node 1421, may impose the frequency band f2 onto code information C4 and then send the code information C4 with respect to the relay node 1422, and may impose the frequency band f3 onto code information C7 and then send the code information C7 with respect to the relay node 1423. In this case, the pieces of code information C1, C4, C7 are codes, each including information about the unique ID of the ground reference node 1411. In accordance with an embodiment, the central node 1440 may assign unique codes corresponding to the respective ground reference nodes 1411, 1412 and 1413.

Furthermore, likewise, the ground reference node 1412 may assign the different frequency bands f1, f2 and f3 to the relay nodes 1421, 1422 and 1423. In this case, the assignment of the frequency bands to the respective relay nodes 1421, 1422 and 1423 may be performed by the central node 1440, and information about the assignment may be transferred to the ground reference nodes 1411, 1412 and 1423.

Like the ground reference node 1411, the ground reference node 1412 may impose the frequency band f1 onto code information C2 and then send the code information C2 with respect to the relay node 1421, may impose the frequency band f2 onto code information C5 and then send the code information C5 with respect to the relay node 1422, and may impose the frequency band f3 onto code information C8 and then send the code information C8 with respect to the relay node 1423. In this case, the pieces of code information C2, C5 and C8 are codes, each including information about the unique ID of the ground reference node 1413. In accordance with an embodiment, the central node 1440 may assign unique codes corresponding to the respective ground reference nodes 1411, 1412 and 1413.

Furthermore, likewise, the ground reference node 1413 may assign the different frequency bands f1, f2 and f3 to the relay nodes 1421, 1422 and 1423. In this case, the assignment of the frequency bands to the respective relay nodes 1421, 1422 and 1423 may be performed by the central node 1440, and information about the assignment may be transferred to the ground reference nodes 1411, 1412 and 1423.

Likewise, the ground reference node 1413 may impose the frequency band f1 onto code information C3 and then send the code information C3 with respect to the relay node 1421, may impose the frequency band f2 onto code information C6 and then send the code information C6 with respect to the relay node 1422, and may impose the frequency band f3 onto code information C9 and then send the code information C9 with respect to the relay node 1423. In this case, the pieces of code information C3, C6, C9 are codes, each including information about the unique ID of the ground reference node 1413. In accordance with an embodiment, the central node 1440 may assign unique codes corresponding to the respective ground reference nodes 1411, 1412 and 1413.

In this case, all the code signals transmitted by the ground reference nodes 1411, 1412 and 1413 are synchronized and transmitted at the same time.

The relay node 1421 receives the code signal C1 of the band f1 from the ground reference node 1411, the code signal C2 of the band f1 from the ground reference node 1412, and the code signal C3 of the band f1 from the ground reference node 1413, amplifies the code signals, superposes the amplified signals, and sends the superposed signals to the reception node 1430.

TDOAs between the code signals C1, C2 and C3 are values corresponding to the differences between the distances between the ground reference nodes 1411, 1412 and 1413 and the relay node 1421. The TDOAs between the code signals C1, C2 and C3 are determined at the times at which the code signals C1, C2 and C3 have reached the relay node 1421, and the relay node 1421 superposes the code signals C1, C2 and C3 and sends the code signals C1, C2 and C3 to the reception node 1430. Accordingly, the reception node 1430 may also receive superposed code signals into which the TDOAs between the code signals C1, C2 and C3 has been incorporated, and may measure TDOAs. In this case, since the code signals C1, C2 and C3 are synchronized by the ground reference nodes 1411, 1412 and 1413 and then transmitted, the reception node 1430 may calculate the location of the relay node 1421 based on the TDOAs between the code signals C1, C2 and C3 in accordance with a triangulation method.

In addition, the relay nodes 1422 and 1423 receive the code signals C4 and C7 in the band f1 from the ground reference node 1411, the code signals C5, C8 in the band f1 from the ground reference node 1412, and the code signals C6, C9 in the band f1 from the ground reference node 1413, amplifies the code signals, superposes the amplified signals, and sends the superposed signals the reception node 1430.

TDOAs between the code signals C4, C5, C6 and between the code signals C7, C8, C9 are values corresponding to differences between the distances between the ground reference nodes 1411, 1412 and 1413 and between the relay nodes 1422, 1423. The TDOAs between the code signals C4, C5, C6 and between the code signals C7, C8 and C9 are determined at the times at which the code signals C4, C5 and C6 and the code signals C7, C8 and C9 have reached the relay nodes 1422, 1423, and the relay nodes 1422 and 1423 superpose the code signals C4, C5 and C6 and the code signals C7, C8 and C9 and then send the code signals to the reception node 1430. Accordingly, the reception node 1430 may also receive superposed code signals into which the TDOAs between the code signals C4, C5 and C6 and between the code signals C7, C8 and C9 have been incorporated, and may measure TDOAs. In this case, since C4, C5 and C6 and C7, C8 and C9 are synchronized by the ground reference nodes 1411, 1412 and 1413 and then transmitted, the reception node 1430 may calculate the location of the relay node 1421 based on the TDOAs between C4, C5 and C6 and between C7, C8 and C9 in accordance with a triangulation method.

FIG. 14 has illustrated the embodiment in which the different frequencies f1, f2 and f3 are assigned to the relay nodes 1421, 1422 and 1423, but the present invention is not limited to the embodiment of FIG. 14. An embodiment in which the same frequency band is assigned to the relay nodes 1421, 1422 and 1423 is also possible.

If the same frequency band is assigned to the relay nodes 1421, 1422 and 1423, each of the relay nodes 1421, 1422 and 1423 may be identified using a method other than a frequency division method, such as time division or code division. There is no limitation to a method of identifying each of the relay nodes 1421, 1422 and 1423 because the reception node 1430 needs only to determine a relay node through which a superposed and received unique code has passed.

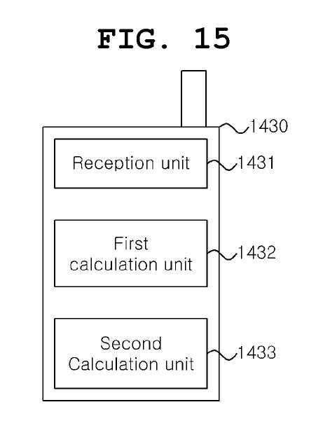

FIG. 15 illustrates the conceptual configuration of the reception node 1430 illustrated in FIG. 14. The reception node 1430 includes a reception unit 1431, a first calculation unit 1432, and a second calculation unit 1433.

The reception unit 1431 functions to receive unique signals that originate from the ground reference node 1411 and that are transferred by the aerospace/satellite relay node 1421.

The reception node 1430 may previously store information about the unique ID codes and locations of the ground reference nodes 1411, 1412 and 1413. When the information about the unique IDs of the respective ground reference nodes 1411, 1412 and 1413 is extracted from unique signals received by the reception unit 1430, the first calculation unit 1432 calculates the locations of the three or more relay nodes 1421, 1422 and 1423 based on the TDOAs of the superposed codes C1, C2, C3 and C4, C5, C6 and C7, C8, C9 of the unique signals received from the relay nodes 1421, 1422 and 1423 using the information about the unique ID codes and locations previously stored in the reception node 1430.

The second calculation unit 1433 calculates the location of the reception node 1430 in accordance with triangulation using the calculated locations of the relay nodes 1421, 1422 and 1423 and the distances between the relay nodes 1421, 1422 and 1423 and the reception node 1430. Since all the unique signals C1 to C9 received by the reception node 1430 have been synchronized, transmission times in the ground reference nodes 1411, 1412 and 1413 is the same. Accordingly, transmission distances from the respective ground reference nodes 1411, 1412 and 1413 to the reception node 1430 via the relay nodes 1421, 1422 and 1423 may be calculated based on the times at which the unique signals have reached the reception node 1430 and the differences between the transmission times. The reception node 1430 has already calculated the locations of the relay nodes 1421, 1422 and 1423, and is aware of the locations of the ground reference nodes 1411, 1412 and 1413. Accordingly, the reception node 1430 may obtain the distances between the relay nodes 1421, 1422 and 1423 and the reception node 1430 by excluding the distances between the ground reference nodes 1411, 1412 and 1413 and the relay nodes 1421, 1422 and 1423 from the total arrival distances of the unique signals.

The first calculation unit 1432 calculates the locations and distances between the ground reference nodes and the aerospace/satellite relay nodes using the TDOAs between the three or more received unique signals. The second calculation unit 1433 calculates its own location based on the calculated locations of the three or more aerospace/satellite relay nodes and the distances between the reception node and the three or more aerospace/satellite relay nodes.

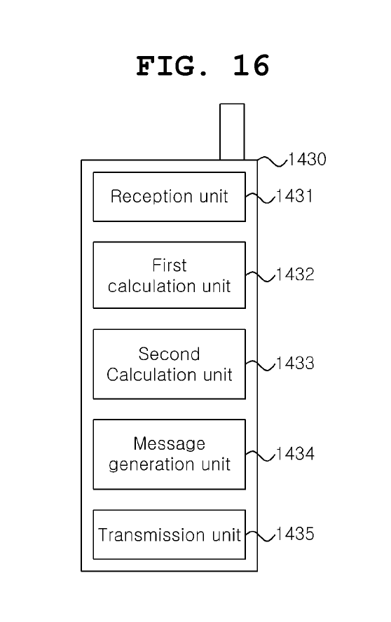

FIG. 16 illustrates the conceptual configuration of the reception node 1430 capable of feedback, illustrated in FIG. 14.

The operations of a reception unit 1431, a first calculation unit 1432, and a second calculation unit 1433 of FIG. 16 are the same as those described with reference to FIG. 15, and thus descriptions thereof are omitted.

Referring to FIG. 16, the reception node 1430 feeds back the measured values of downlink channels over which the unique signals are received from the ground reference nodes 1411, 1412 and 1413 through the uplink of the transmission unit 1435. Furthermore, the message generation unit 1434 of the reception node 1430 may generate a low-speed message depending on the surrounding environment of the reception node 1430, and may send the low-speed message to the ground reference nodes 1411, 1412 and 1413 via an uplink. In this case, the message generated and transmitted by the reception node 1430 may include the measured values of the downlink channels, or may include information about a weather environment, an unexpected situation, and a natural disaster around the reception node 1430.

Furthermore, the reception node 1430 may feed back the channel measured values, and may generate a message indicative that a positioning process has failed due to poor channel characteristics and then feed back the generated message, if necessary.

The reception node 1430 may send information about a surrounding environment or channel characteristics to the ground reference nodes 1411, 1412 and 1413 or the central node 1440, and may also send and receive information about a surrounding environment or channel characteristics to and from another reception node (not illustrated). In this case, the reception node 1430 may communicate with surrounding reception nodes using communication channels with the relay nodes 1421, 1422 and 1423. The reception node 1430 may communicate with another reception node under the control of the ground reference nodes 1411, 1412 and 1413 or the central node 1440, and may communicate with another reception node in an environment in which the reception node 1430 is not controlled by the ground reference nodes 1411, 1412 and 1413 or the central node 1440. The reception node 1430 may form a mesh system in order to communicate with another reception node in an environment in which the reception node 1430 is not controlled by the ground reference nodes 1411, 1412 and 1413 or the central node 1440.

In this case, the reception node 1430 may send and receive information in the form of a short message in order to communicate with the ground reference nodes 1411, 1412 and 1413, the central node 1440, or another reception node.

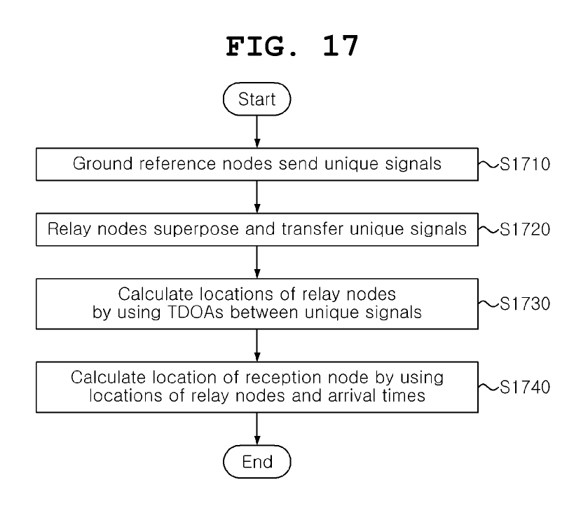

FIG. 17 illustrates an operational flowchart of a positioning method that is performed in the three or more ground reference nodes-based aerospace/satellite communication relay positioning system according to an embodiment of the present invention. The ground reference nodes 1411, 1412 and 1413 assign respective frequencies to the relay nodes 1421, 1422 and 1423, assign unique codes to the relay nodes 1421, 1422 and 1423, and send the unique codes at step S1710.

The relay nodes 1421, 1422 and 1423 superpose the received unique codes and transfer the superposed unique codes to the reception node 1430 at step S1720. The first calculation unit 1432 of the reception node 1430 may calculate the locations of the respective relay nodes 1421, 1422 and 1423 by using the TDOAs between the unique signals, and may be aware of the locations of the relay nodes 1421, 1422 and 1423 at step S1730.

The second calculation unit 1433 of the reception node 1430 may calculate the location of the reception node 1430 using the obtained locations of the relay nodes 1421, 1422 and 1423 and the arrival times (or TOAs) of the unique signals received by the reception node 1430 at step S1740.

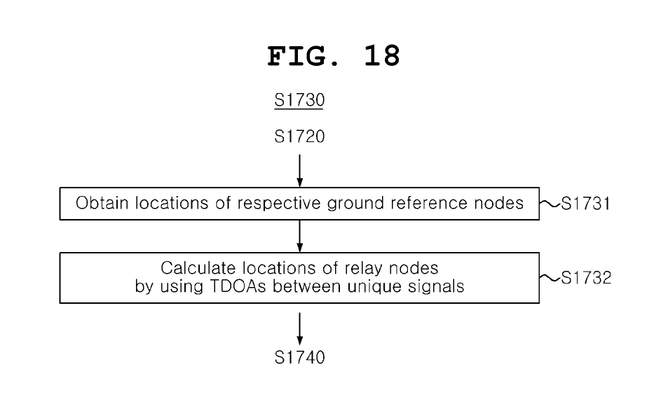

FIG. 18 is an operational flowchart illustrating step S1730 of FIG. 17 in more detail.

Referring to FIG. 18, the reception node 1430 identifies the ground reference nodes 1411, 1412 and 1413 based on the respective received unique ID codes. The reception node 1430 obtains the locations of the identified ground reference nodes 1411, 1412 and 1413 based on corresponding relations between the already known unique ID codes and pieces of location information of the ground reference nodes 1411, 1412 and 1413 at step S1731.

The first calculation unit 1432 of the reception node 1430 calculates the locations of the respective relay nodes 1421, 1422 and 1423 using the TDOAs between the unique signals and the locations of the ground reference nodes 1411, 1412 and 1413 at step S1732.

In this case, the ground reference nodes 1411, 1412 and 1413 may previously receive the respective pieces of location information from the central node 1440, and may store the received location information. Each of the ground reference nodes 1411, 1412 and 1413 may previously transfer its own location to the reception node 1430 through a downlink channel.

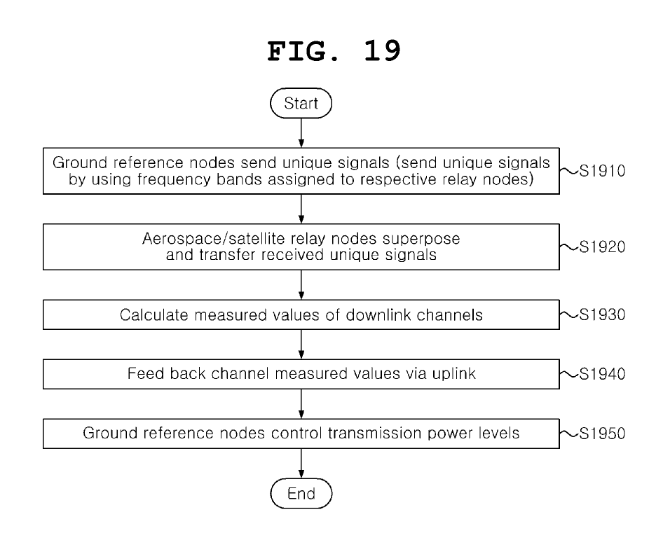

FIG. 19 is an operational flowchart illustrating an overall feedback process, such as feedback from the reception node 1430 corresponding to FIG. 17 and responses from the respective ground reference nodes 1411, 1412 and 1413 corresponding to the feedback. Referring to FIG. 19, the ground reference nodes 1411, 1412 and 1413 send the respective unique signals at step S1910. In this case, the unique signals may be transmitted using the frequency bands assigned to the respective relay nodes 1421, 1422 and 1423.

The relay nodes 1421, 1422 and 1423 superpose and transfer the respective received unique signals and the superposed unique signals are transferred to the reception node 1430 through the retransfer process at step S1920.

Thereafter, the reception node 1430 measures and calculates the characteristic value of a downlink channel over which the superposed unique signals are transferred at step S1930. In this case, a process of measuring the characteristic value may be performed using the superposed unique signal, and may be performed using a separate pilot signal for measuring the channel characteristics in addition to the unique signal for positioning.

The reception node 1430 may feed back the channel measured values via an uplink at step S1940. In this case, if a positioning process fails due to poor channel characteristics, the reception node 1430 may additionally feed back a separate message indicative that the positioning process has failed.

Each of the ground reference nodes 1411, 1412 and 1413 may control its transmission power level based on the feedback information at step S1950. If a message indicative that a positioning process has failed is fed back, each of the ground reference nodes 1411, 1412 and 1413 may attempt to overcome poor channel characteristics by raising the transmission power level.

A ground reference node-based positioning method or a method of sending positioning information according to embodiments of the present invention may be implemented in the form of program instructions and stored in a computer-readable medium. The computer-readable medium may store the program instructions, data files, and data structures solely or in combination. The program instructions recorded on the medium may have been specially designed and implemented for the present invention, or may have been known to those skilled in the computer software field and have been used. Examples of the computer-readable medium include all types of hardware devices specially configured to store and execute the program instructions, such as magnetic media including a hard disk, a floppy disk, and a magnetic tape, optical media including Compact Disc (CD) ROM and Digital Video Disc (DVD) ROM, magneto-optical media including a floptical disk, RAM, and flash memory. Examples of the program instructions include machine code, such as one produced by a compiler, and high-level language code executable by computers using an interpreter. The hardware apparatus may be implemented using one or more software modules for performing the operation of the present invention, and the vice versa.

Although the embodiments of the present invention have been described in connection with specific matters, such detailed elements, and the limited embodiments and drawings, they are provided only to help general understanding of the present invention, and the present invention is not limited to the embodiments. A person having ordinary skill in the art to which the present invention pertains may modify the present invention in various ways based on the above description.

Accordingly, the spirit of the present invention should not be construed as being limited to the embodiments, and not only the attached claims but also all equivalent modifications thereof should be constructed as belonging to the scope of the present invention.

The present invention relates to a positioning system and, more particularly, to a positioning system in which the reception node calculates its own location using the ground reference node and the aerospace/satellite communication relay nodes, and a positioning method and apparatus used in the positioning system. The present invention has been contrived to aim at constructing the positioning system that is not a system dependent on the global GPS system, that may be used as independent and local systems, that is flexible in the case of national security, commercial use and combat situations, and that is considerably less influenced by the threat of enemy jamming signals.

A GPS technology using a conventional GNSS technology is disadvantageous in that a reception rate is low in mountainous areas due to weak signals, and may become a fatal weak point in military equipment using the GPSs because it was vulnerable to malicious signal jamming.

The present invention uses the configuration of the independent positioning system in which the reception node is capable of measuring its own location using the ground reference node and the aerospace/satellite relay nodes and a technology for implementing the configuration without depending on a conventional positioning system based on middle earth orbit satellites having a global service capability.

The present invention can improve the malicious signal jamming handling capability compared to a conventional GNSS system that is vulnerable to malicious signal jamming, can lower dependence on the GNSS by applying the present invention to national defense field weapon systems, and can provide the positioning capability for weapon systems even in a GNSS signal jamming situation.

The present invention can be applied to positioning systems used in various fields, such as civilian fields, the identification of the locations of merchant ships/fishing boats on the sea, harbor/aviation/traffic control, and the management of facilities. Furthermore, the present invention can be managed along with a disaster broadcasting system because a low-speed message according to aerospace/satellite communication relay can be broadcast to the reception node. If the reception node has the transmission capability, the reception node may also function as a sensor node through low-speed message communication. This enables bidirectional communication between the reception node and the ground reference node. In this case, the present invention may be managed along with a disaster broadcasting system or an emergency broadcasting system. Furthermore, since the transmission power level of the ground reference node can be controlled using information fed back by the reception node, the present invention may also be applied to a hybrid data communication scheme in which various types of information are transmitted and received along with positioning-related information.

The positioning system of the present invention may be implemented by using a single ground reference node and three or more aerospace/satellite relay nodes. In this case, the reception node can relatively simply implement a process of calculating its location because information about the locations of the ground reference nodes and the aerospace/satellite relay nodes is provided by the ground reference node to the reception node.

Furthermore, the positioning system according to another embodiment of the present invention may be implemented by using three or more ground reference nodes (ground reference nodes) and three or more aerospace/satellite relay nodes. In this case, the reception node can calculate its location for itself even when information about the locations of the ground reference nodes and the aerospace/satellite relay nodes is not provided to the reception node.

Furthermore, the positioning system of the present invention can compare information about the locations of the aerospace/satellite relay nodes, calculated by the reception node, with location information transmitted by the ground reference node, and can supplement or compensate for the inaccuracy the location information by using the case where a single ground reference node and three or more aerospace/satellite relay nodes are used and the case where three or more ground reference nodes and three or more aerospace/satellite relay nodes are used in parallel.

What is claimed is:

1. A ground reference node-based positioning method, comprising:
receiving, at a reception node, reference signals transmitted by a ground reference node and transferred via three or more aerospace/satellite relay nodes, respectively;
obtaining, at the reception node, information about a location of the ground reference node and locations of the respective aerospace/satellite relay nodes;
calculating, at the reception node, a location of the reception node by using the location of the ground reference node, the locations of the respective aerospace/satellite relay nodes, and Times of Arrival (TOAs) related to transfer paths of the reference signals.

2. The positioning method of claim 1, wherein the calculating the location of the reception node comprises:
calculating differences between distances from the aerospace/satellite relay nodes to the reception node by using Time Differences Of Arrival (TDOAs) related to the transfer paths of the reference signals and the locations of the respective aerospace/satellite relay nodes; and
determining the location of the reception node by using differences between the distances from the aerospace/satellite relay nodes to the reception node.

3. The positioning method of claim 2, wherein the determining the location of the reception node comprises:
generating a hyperbolas, that is, a set of specific points at which a difference between distances from different aerospace/satellite relay nodes of the aerospace/satellite relay nodes is constant, on two or more geographical coordinates; and
determining the location of the reception node by using an intersection point of the generated two or more hyperbolas.

4. The positioning method of claim 1, further comprising generating, at the reception node, code signals of the aerospace/satellite relay nodes by using time information synchronized with that of the ground reference node,
wherein the calculating the location of the reception node comprises:
calculating Round Trip Times (RTTs) of the transfer paths extending via the aerospace/satellite relay nodes using times at which the code signals of the aerospace/satellite relay nodes are generated and TDOAs related to the transfer paths of the reference signals;
calculating distances from the aerospace/satellite relay nodes to the reception node using the RTTs, the location of the ground reference node, and the locations of the aerospace/satellite relay nodes; and
determining the location of the reception node by using the distances from the aerospace/satellite relay nodes to the reception node.

5. The positioning method of claim 4, wherein the calculating the distances from the aerospace/satellite relay nodes to the reception node comprises:
calculating uplink transfer delay times from the ground reference node to the aerospace/satellite relay nodes by using the location of the ground reference node and the locations of the aerospace/satellite relay nodes; and
subtracting the uplink transfer delay times from the RTTs of the transfer paths extending via the aerospace/satellite relay nodes.

6. The positioning method of claim 1, wherein the obtaining the information about the locations comprises receiving the information about the location of the ground reference node and the locations of the respective aerospace/satellite relay nodes that is broadcast via one or more of the aerospace/satellite relay nodes from the ground reference node or over a separate wired or wireless communication network.

7. The positioning method of claim 1, wherein the obtaining the information about the locations comprises extracting the information about the locations of the aerospace/satellite relay nodes from the reference signals transferred via the aerospace/satellite relay nodes.

8. The positioning method of claim 1, further comprising a step of sending by the reception node, information about a surrounding environment via an uplink.

9. The positioning method of claim 1, further comprising feeding back, by the reception node, measured values of downlink channels over which the reference signals are received via uplinks.

10. The positioning method of claim 1, further comprising communicating, by the reception node, with a second reception node by using communication channels with the aerospace/satellite relay nodes.

11. A ground reference node-based method of sending positioning information, comprising:
monitoring, by the ground reference node, locations of respective three or more aerospace/satellite relay nodes by communicating with the aerospace/satellite relay nodes periodically in order to control postures of the respective aerospace/satellite relay nodes;
transferring, by the ground reference node, information about a location of the ground reference node and the locations of the three or more aerospace/satellite relay nodes to a reception node; and
sending reference signals transferred from the ground reference node to the reception node via the respective three or more aerospace/satellite relay nodes.

12. The method of claim 11, wherein the transferring the information about the locations to the reception node comprising broadcasting the information about the locations via one or more of the aerospace/satellite relay nodes from the ground reference node or via communication channels different from communication channels of the reference signals over a separate wired or wireless communication network.

13. The method of claim 11, wherein the transferring the information about the locations to the reception node comprises transferring the information about the locations of the three or more aerospace/satellite relay nodes to the reception node via an aerospace/satellite relay node that corresponds to the information about each of the locations of the three or more aerospace/satellite relay nodes while sending the reference signals is performed.

14. The method of claim 11, wherein the sending the reference signals comprises:
assigning different resources to the three or more aerospace/satellite relay nodes; and
sending the reference signals extending via the respective three or more aerospace/satellite relay nodes by using the assigned resources.

15. A ground reference nodes-based positioning method, comprising:
receiving reference signals transmitted by a plurality of ground reference nodes and transferred by a plurality of aerospace/satellite relay nodes;
calculating locations of the plurality of respective aerospace/satellite relay nodes by using Times Difference Of Arrival (TDOAs) of the received reference signals; and
calculating a location of a reception node by using the calculated locations of the plurality of aerospace/satellite relay nodes and Times Of Arrival (TOAs) of the received reference signals.

16. The positioning method of claim 15, wherein the TDOAs correspond to differences between distances between the plurality of ground reference nodes and the plurality of aerospace/satellite relay nodes.

17. The positioning method of claim 15, wherein each of the reference signals comprises information about a unique identification (ID) of each of the plurality of ground reference nodes.

18. The positioning method of claim 17, further comprising previously storing information about the unique ID and location of each of the plurality of ground reference nodes;
wherein the calculating the locations of the plurality of respective aerospace/satellite relay nodes comprises:
extracting the information about the unique ID of each of the plurality of ground reference nodes from each of the reference signals, and obtaining the information about the locations of the plurality of ground reference nodes; and
calculating the locations of the plurality of aerospace/satellite relay nodes by using the obtained information about the locations of the plurality of ground reference nodes and a TDOA of each of the received reference signals.

19. The positioning method of claim 15, wherein the reference signals transferred by the plurality of respective aerospace/satellite relay nodes are configured such that unique ID information transmitted by the plurality of ground reference nodes are superposed, and are then transmitted.

20. The positioning method of claim 15, wherein the reference signals are synchronized by the plurality of reference nodes, and are transmitted to the plurality of aerospace/satellite relay nodes.

21. A positioning system including a ground reference node and a reception node, the position system comprising:
the ground reference node configured to send reference signals to the reception node via respective three or more aerospace/satellite relay nodes, wherein a location of the ground reference node is known; and
the reception node configured to:
receive the reference signals; and
calculate a current location using Times Of Arrival (TOAs) of the reference signals;
wherein the ground reference node shares information about the location of the ground reference node and locations of the respective three or more aerospace/satellite relay nodes with the reception node; and
wherein the reception node calculates the current location by using the shared information about the locations and the TOAs of the reference signals.

22. The positioning system of claim 21, wherein:
the reception node feeds back information about states of channels through which the reference signals are transferred; and
the ground reference node controls power levels of transmission signals in response to the feedback information of the states of the channels.

23. The positioning system of claim 21, wherein the ground reference node shares the information about the locations of the respective three or more aerospace/satellite relay nodes with the reception node by sending the information about the locations with the information about the locations being included in the reference signals transferred via the aerospace/satellite relay nodes corresponding to the information about the respective locations.

24. A positioning apparatus based on a ground reference node, comprising:
a reception unit configured to receive reference signals that are transmitted by the ground reference node and that are transferred via respective three or more aerospace/satellite relay nodes;
a location acquisition unit configured to obtain information about a location of the ground reference node and locations of the respective aerospace/satellite relay nodes; and
a calculation unit configured to calculate a location of a reception node by using the location of the ground reference node, the locations of the respective aerospace/satellite relay nodes, Times of Arrival (TOAs) related to transfer paths of the reference signals.

25. The positioning apparatus of claim 24, further comprising:
a message generation unit configured to generate a transmission message by using one or more of information about a surrounding environment of the reception node and a measured value of a downlink channel over which the reference signals are received by the reception node; and
a transmission unit configured to send the generated transmission message via an uplink.

26. A ground reference nodes-based positioning system, comprising:
a plurality of the ground reference nodes configured to synchronize and send respective unique signals, wherein locations of the plurality of ground reference nodes are known;
a plurality of aerospace/satellite relay nodes configured to superpose and transfer the respective unique signals transmitted by the plurality of ground reference nodes; and
a reception node configured to identify locations of a plurality of respective aerospace/satellite relay nodes by using Time Differences Of Arrival (TDOAs) of the unique signals that are superposed and transferred by the plurality of aerospace/satellite relay nodes;
wherein the reception node calculates a location of the reception node by using the identified locations of the plurality of respective aerospace/satellite relay nodes.

27. The positioning system of claim 26, wherein each of the plurality of ground reference nodes assigns different frequency bands to the plurality of respective aerospace/satellite relay nodes, and sends the synchronized unique signals using the assigned frequency bands.

28. The positioning system of claim 26, wherein:
the reception node feeds back information about states of channels over which the unique signals are transferred, and
each of the plurality of reference nodes controls a power level of a transmission signal in response to the feedback information about a state of each channel.

29. A ground reference nodes-based positioning apparatus, comprising:
a reception unit configured to receive reference signals that are transmitted by a plurality of the ground reference nodes and that are transferred by a plurality of aerospace/satellite relay nodes;
a first calculation unit configured to calculate locations of the plurality of respective aerospace/satellite relay nodes by using Time Differences Of Arrival (TDOAs) of the received reference signals; and
a second calculation unit configured to calculate a location of a reception node by using the calculated locations of the plurality of respective aerospace/satellite relay nodes and Times Of Arrival (TOAs) of the received reference signals.
